(19) United States
(12) Patent Application Publication
(10) Pub. No.: US 2004/0210588 A1
(43) Pub. Date: Oct. 21, 2004

(54) Methods and apparatus for address lookup

(76) Inventors: Mark B. Simkins, Allentown, PA (US); Seung Yeop Yang, Allentown, PA (US)

Correspondence Address: Ryan, Mason & Lewis, LLP, Suite 205, 1300 Post Road, Fairfield, CT, 06430, US

(21) Appl. No.: 10/418,601

(22) Filed: Apr. 18, 2003

(51) Int. Cl. G06F 17/00

(52) U.S. Cl. 707/100

(57) ABSTRACT

Address lookup techniques are presented that process input data and that utilize a number of node information structures. One or more of the node information structures is part of a radix tree. A bit or bits of the input data are selected by using a next node selector from a first node information structure. The first node information structure also comprises a pointer. One or more memory accesses are performed by using at least one memory address defined at least in part by the selected one or more bits and the pointer from the first node information structure. The one or more memory accesses access another node information structure comprising another pointer. In an illustrative embodiment, this process is repeated until a resultant address is determined. Node information structures may comprise leaf/branch indicators, which indicate whether a node is a leaf or a branch. When a leaf branch indicator indicates a leaf, the resultant address is found.

### FIELD OF THE INVENTION

The present invention relates generally to data communications, and more particularly to address lookup in data communication systems.

### BACKGROUND OF THE INVENTION

A common problem in data communication systems involves the need to perform some type of address lookup on information entering a switching device of the system. For example, routers use an incoming internet protocol (IP) address to look up a destination port for a packet. A straightforward way of performing an address lookup is to directly use all the bits of the incoming information as an address input to a memory, where each lookup result (called a “resultant address” herein) is stored at the corresponding memory location. However, this “direct mapped” address lookup method is an inefficient use of memory. A communication system using the asynchronous transfer mode (ATM) specification provides an example of the inefficiency of direct mapped address lookup. ATM address lookup is the process of mapping cell address information, such as a virtual path identifier (VPI) and virtual channel identifier (VCI), of a received ATM cell to a corresponding internal connection identifier (ID), which is a resultant address. The connection ID is then typically used to address a context memory to obtain connection information. The context memory contains virtual channel (VC) context information. In the early stages of ATM deployment, a common approach to this problem was to use direct mapping, in which a subfield of VPI/VCI is extracted and used directly to address the context memory. This represents a compromise, however, as only a portion of the entire VPI/VCI address space can be used. If the entire VPI/VCI address range were mapped directly to memory, it would require 2²⁸ context memory storage locations as there are 28 bits reserved for the VPI/VCI information. Thus, while direct mapped address lookup methods are typically very fast, the memory requirements can be onerous.

Because of high memory requirements for direct mapped memory lookup, other memory organizations have been used. One type of structure used to perform memory lookup is a radix tree. A radix tree is separated into nodes. There is a root node that connects through branches to two additional nodes. Each of these two additional nodes are connected through branches to two more nodes and so on until leaves of the radix tree are reached. A leaf is an end of the tree. A benefit to this structure is that nodes may be added, deleted or modified. Thus, if it is known that only a certain number of nodes need be created, the memory requirement for a radix tree can be smaller than that required for direct mapped address lookup.

Radix trees of various base values (referred to as “radix-n,” where n=1,2,3, . . . , and where “radix” with no suffix implies radix-1) are possible. A radix-n tree has 2ⁿ possible branches per node. For example, the radix tree described above has two possible branches for each node. A radix-2 tree has four possible branches for each node, while a radix-4 tree has 16 possible branches for each node. In general, address lookups are performed in two stages. In a primary search, a primary key is used to determine, for instance, a root node of a secondary radix tree. The primary search is generally a direct mapped address lookup. A secondary key is used to “walk” down the secondary radix tree. At each subsequent node in the radix tree, a lookup either reaches a leaf of the radix tree or another branch is taken. A leaf contains the resultant address used to access connection context. A radix tree can end early or skip nodes. This is called a “reduced” radix tree to distinguish this type of radix tree from a “full” radix tree. Reduced radix trees have smaller memory and memory access requirements than full radix trees.

Full radix and reduced radix trees generally require less memory than direct mapped address lookup techniques, while still providing reasonably fast lookup times. However, address lookup techniques using a radix tree of one base value are hard to modify in order to have the address lookup techniques use a radix tree of a different base value. For instance, an address lookup technique using a radix-2 tree will usually have to be substantially rewritten or redeveloped in order to use a radix-4 tree.

Thus, there is a need to further improve address lookup in order to make address lookup techniques more extensible.

### SUMMARY OF THE INVENTION

The present invention provides address lookup methods and apparatus that are, for instance, more extensible yet also create speed improvements over conventional address lookup techniques.

In one aspect of the invention, address lookup techniques are presented that process input data. The address lookup techniques utilize a number of node information structures. One or more of the node information structures is part of a radix tree. A bit or bits of the input data are selected by using a next node selector from a first node information structure. The first node information structure also comprises a pointer. One or more memory accesses are performed by using at least one memory address defined at least in part by the selected one or more bits and the pointer from the first node information structure. The one or more memory accesses access another node information structure comprising another pointer and generally another next node selector.

In another aspect of the invention, an additional bit or additional bits of the input data are selected, and the other pointer is used to determine another node information structure. This process may be repeated until a resultant address is determined. The node information structures may comprise leaf/branch indicators, which indicate whether a node to which an associated pointer references is a leaf or a branch. When a leaf/branch indicator indicates a leaf, the resultant address is found.

In an illustrative embodiment of the invention, a resultant address may be, for an asynchronous transfer mode (ATM) system, a connection identifier (ID). The connection ID may be used to determine a virtual channel (VC) context for a cell of the ATM system. The input data for the ATM system can be a virtual channel identifier (VCI) from the cell. Additionally, a primary key search may be performed to select the first node information structure, which may be part of a primary search table. The primary key may be, for example, a combination of the port and a virtual path identifier. The primary key search may be performed through direct access memory lookup techniques, for instance. The first node information then generally references a root node of a secondary radix tree, where the root node comprises the other node information structure.

### BRIEF DESCRIPTION OF THE DRAWINGS

FIG. 1 illustrates primary and secondary address lookups for an exemplary asynchronous transfer mode (ATM) communication system;

FIG. 2 illustrates a secondary radix tree and a node data structure for the exemplary ATM communication system of FIG. 1;

FIG. 3 is a block diagram of a network switch operating in accordance with a preferred embodiment of the present invention;

FIG. 4 is a diagram of an exemplary logical search architecture for primary and secondary key address lookups in accordance with a preferred embodiment of the present invention;

FIG. 5 is an example of primary and secondary keys for an ATM communication system;

FIG. 6 is a block diagram of an exemplary primary key search table;

FIG. 7 is a block diagram of an exemplary secondary radix tree and exemplary node information associated therewith;

FIG. 8 is an exemplary diagram of a selector look-ahead reduced radix tree for secondary key address lookup and a primary search result used to access the selector look-ahead reduced radix tree;

FIG. 9 is an exemplary lookup engine for performing secondary key address lookups using the secondary radix tree structure of FIG. 7;

FIGS. 10 through 14 illustrate adding and removing ATM connections when a secondary radix tree is empty, the secondary radix tree contains only a single virtual connection (VC), an insertion point is at the root of the secondary radix tree, the insertion point is in the middle of the secondary radix tree, and a new table entry is inserted at a leaf of the secondary radix, respectively;

FIG. 15 is a block diagram of an exemplary secondary radix tree and exemplary node information associated therewith for a radix-4 tree used for ATM secondary key address lookup; and

FIG. 16 is an exemplary lookup engine for performing secondary key address lookups using the secondary radix tree structure of FIG. 15.

### DETAILED DESCRIPTION

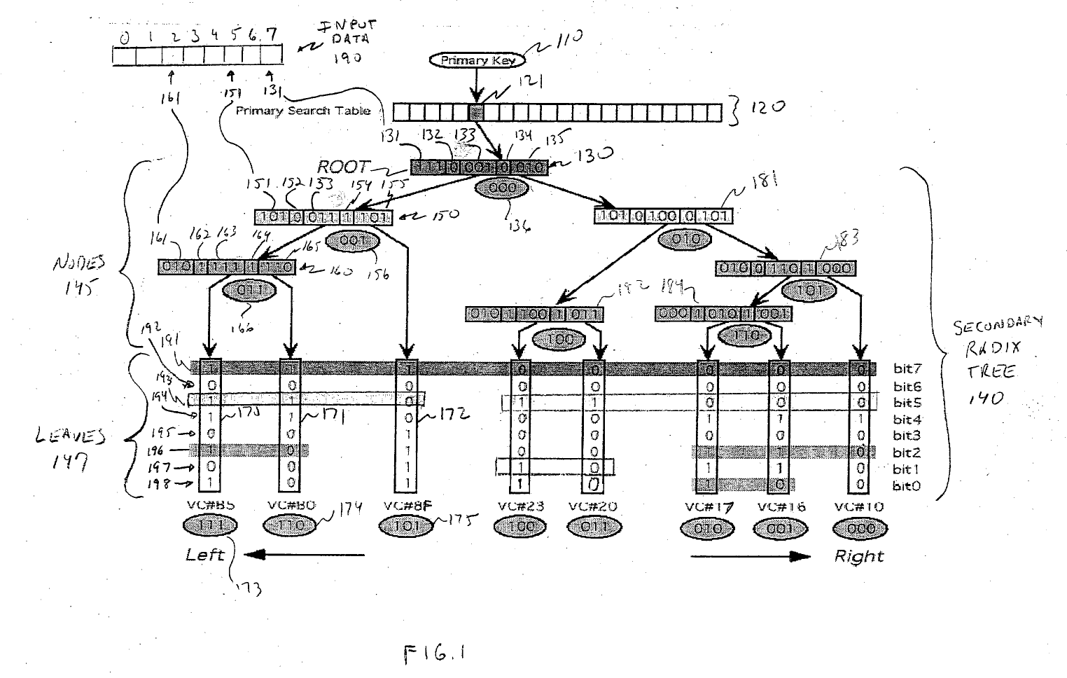

Referring now to FIG. 1, exemplary primary and secondary address lookups for a exemplary asynchronous transfer mode (ATM) communication system are illustrated. A primary key 110 is used to access a primary search table 120 and to select a primary search result 121. In this example, a direct mapping address lookup is used. Primary search result 121 points to a root node 130 of a secondary radix tree 140. The “secondary” indicates, for instance, that the key used during the search is the second key and not the primary key. Root node 130 is at an address indicated by reference numeral 136, so the pointer (not shown) in primary search result 121 is 000. Secondary radix tree 140 is a reduced radix tree in this example and comprises a number of nodes 145 and leaves 147. Root node 130 comprises a selector 131, a first leaf/branch indicator 132, a first pointer 133, a second leaf/branch indicator 134 and a second pointer 135. The selector 131 selects a specific bit (i.e., bit seven) in the input data 190, which is generally a secondary key. If bit seven of the input data 190 is a one, then the first leaf/branch indicator 132 and the first pointer 133 are selected. The first pointer 133 defines a branch that moves to the left on FIG. 1. Conversely, if bit seven of the input data 190 is a zero, then the second leaf/branch indicator 134 and the second pointer 135 are selected. The second pointer 135 defines a branch that moves to the right on FIG. 1.

Assuming that bit seven of the input data 190 is a one, then the first leaf/branch indicator 132 and the first pointer 133 are selected. The first leaf/branch indicator 132 indicates that a branch exists and that the first pointer 133 points to address “001” (as indicated by reference 156), which holds node 150 of the branch. Node 150 comprises a selector 151, a first leaf/branch indicator 152, a first pointer 153, a second leaf/branch indicator 154 and a second pointer 155. Selector 151 selects bit five of the input data 190. When bit five of the input data 190 is a zero, then the second leaf/branch indicator 154 and second pointer 155 are used. The second leaf/branch indicator 154 indicates that the second pointer 155 references a leaf 172 at address “101” (as shown by reference numeral 175). Leaf 172 contains a resultant address, which in this case indicates a virtual channel (VC) context of 8F in hexadecimal (h). When bit five of the input data 190 is a one, the first leaf/branch indicator 152 and first pointer 153 are used. The first leaf/branch indicator 152 indicates that a branch exists and that the first pointer 153 references a node in the branch. The node 160 is referenced by the “011” in the first pointer 153.

Node 160 comprises a selector 161, a first leaf/branch indicator 162, a first pointer 163, a second leaf/branch indicator 164 and a second pointer 165. Selector 161 selects bit two of the input data 190. When bit two of the input data 190 is a zero, then the second leaf/branch indicator 164 and second pointer 165 are used. The second leaf/branch indicator 164 indicates that the second pointer 165 references a leaf 171 at address “110” (as shown by reference numeral 174). Leaf 171 contains a resultant address, which in this case indicates a VC context of B0h. When bit two of the input data 190 is a one, the first leaf/branch indicator 162 and first pointer 163 are used. The first leaf/branch indicator 162 indicates that the second pointer 163 references a leaf 170 at address “111” (as shown by reference numeral 173). Leaf 170 contains a resultant address, which in this case indicates a VC context of B5h. In general, a VC context is used to access memory in order to determine connection information for an ATM cell.

A reduced radix tree is used as secondary radix tree 140 for the following reasons. Node 130 corresponds to bit 191 of the possible resultant addresses in the leaves 147. This bit 191 must be examined in order to determine which branch to select. Bit 192 does not have to be examined for the branch having node 150, as the bit 192 is zero for each of the leaves 147 in the branch. Node 150 corresponds to bit 193 of the possible resultant addresses. This bit 193 of the leaves 147 does have to be examined, and thus node 150 exists. Bits 194 and 195 do not have to be examined for the branch having node 160. However, bit 196 does have to be examined, and thus node 160 exists. Once bit 196 has been examined, all the bits of the resultant address are known and bits 197 and 198 are not examined. It should be noted that node 181 also corresponds to bit 193, node 183 corresponds to bit 196, node 182 corresponds to bit 197, and node 184 corresponds to bit 198. Thus, a reduced radix tree only stores those nodes that are important to determining the resultant address.

One problem with the secondary radix tree 140 is that each node must be accessed from memory before the bit in the input data 190 is accessed. In this simple example, this is not much of a problem, as an entire node, such as node 150, can be accessed in one memory access. However, when the pointers (e.g., pointers 133 and 135) are large, such as 16 bits, then multiple memory accesses are used to retrieve the entire node. Another problem is that the memory structure used to store the nodes is not symmetric.

It should be noted that radix trees are also known by other names, such as Patricia Trees. An introduction to Patricia Trees is given in U.S. Pat. No. 6,061,712, by H. Tzeng, entitled “Method for IP Routing Table Look-Up,” the disclosure of which is hereby incorporated by reference.

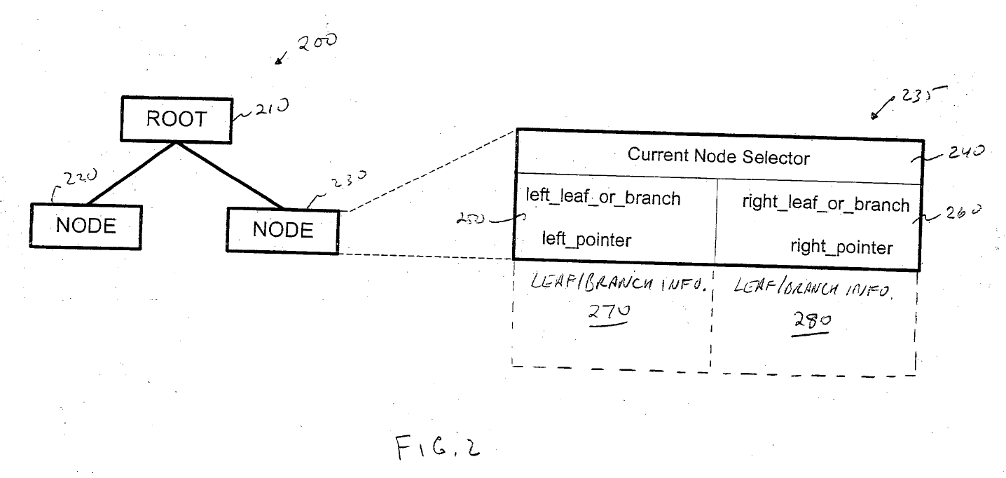

This is shown in FIG. 2, where a radix tree 200 comprises a root node 210 and two branch nodes 220, 230. Radix tree 200 would generally be used to implement secondary radix tree 140 of FIG. 1. A data structure 235 for storing node information is also shown for branch node 230. The data structure 235 comprises a current node selector 240 and two leaf/branch information portions 250, 260. The current node selector 240 is used as both a position indicator within the radix tree 200 and a bit selector for input data (e.g., like input data 190). Leaf/branch information portion 250 comprises a “left_leaf_or_branch” field, indicating whether a leaf or branch is to be accessed, and a “left_pointer” pointer, which points to the leaf or branch. Leaf/branch information portion 260 comprises a “right_leaf_or_branch” field, indicating whether a leaf or branch is to be accessed, and a “right_pointer” pointer, which points to the leaf or branch.

When the radix tree 200 is changed to a radix-2 tree, the leaf/branch information portions 270, 280 need to be added. Each leaf/branch information portion 270, 280 would contain leaf_or_branch field and a pointer. Because the leaf/branch information portions 270, 280 are added to the data structure 235, the data structure 235 itself must be redesigned, which may be complicated. Additionally, the techniques used to search the radix tree 200 must also be rewritten to access the expanded data structure 235, and rewriting search techniques is also complicated.

The present invention solves these problems by, as described in detail below, requiring fewer memory accesses and providing symmetric data structures used to store node information.

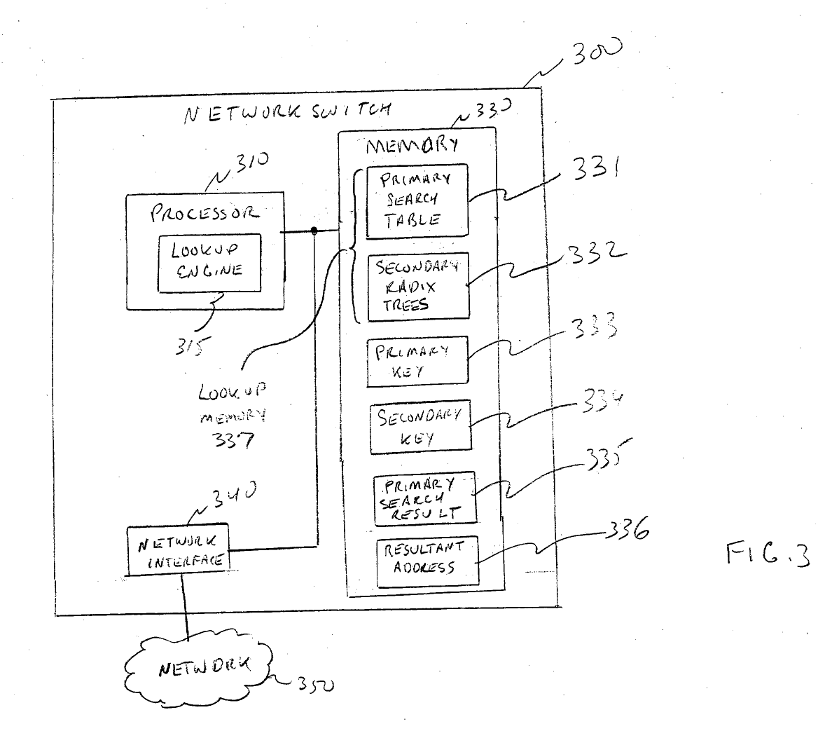

Turning now to FIG. 3, a network switch 300 is shown interoperating with a network 350. The network 350 could be an ATM network or other suitable network or combination of networks. Network switch 300 comprises a processor 310, a memory 330, and a network interface 340. Network interface 340 is coupled to network 350. Processor 310 comprises a lookup engine 315. Memory 330 comprises a lookup memory 337 having a primary search table 331 and secondary radix trees 332, a primary key 333, a secondary key 334, a primary search result 335, and a resultant address 336.

The lookup engine 315 uses the primary key 333 to search the primary search table 331 and to determine a primary search result 335. The search using the primary key will be called a “primary key search” herein. In the examples given below, the primary key search is performed by using a direct mapping address lookup, but the primary key search may be performed through other methods such as radix tree address lookup. The lookup engine 315 uses the primary search result 335 to access one of a number of secondary radix trees 332 and performs a search using the secondary key on the secondary radix tree in the secondary radix trees 332. A search using a secondary key 334 will be called a “secondary key search” herein. The secondary key search produces resultant address 336. In an ATM system, the resultant address 336 can be a connection identifier (ID), which can then be used to access a context memory (not shown) having VC context in order to access connection information. It should be noted that a secondary radix tree may comprise a leaf. In this instance, a secondary key search is unnecessary, as the leaf contains the resultant address 336.

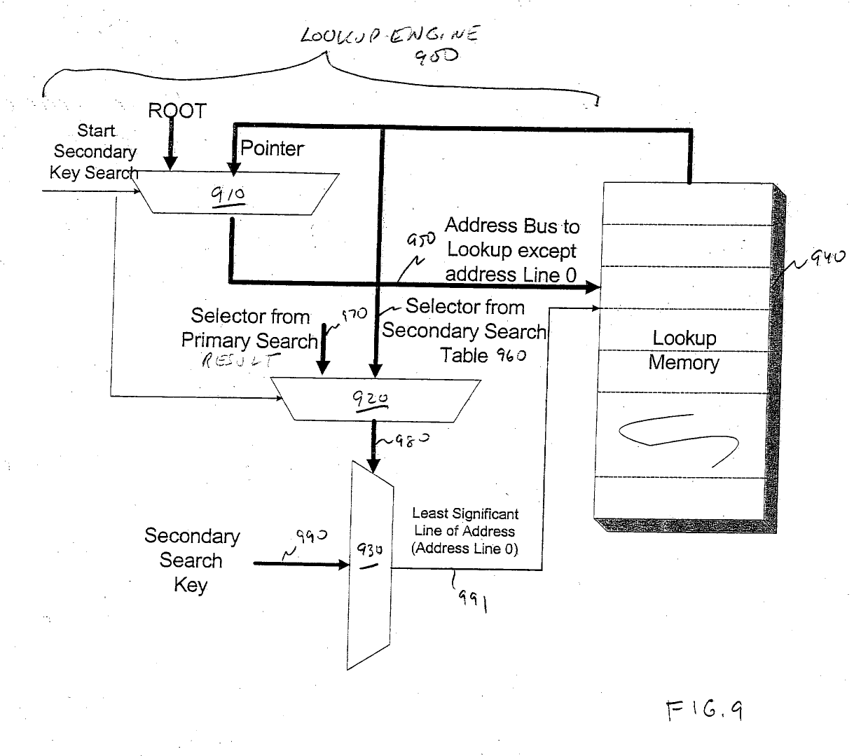

Lookup engine 315 may be implemented through hardware, software, firmware, or a combination of these. Thus, lookup engine 315 may be a series of instructions suitable for causing the processor 310 to perform primary and secondary key searches as described below. Illustratively, the lookup engine may be implemented as hardware, as shown for example in FIG. 9, as part of the processor 310.

The techniques described herein may be implemented as an article of manufacture comprising a machine-readable medium, as part of memory 330 for example, containing one or more programs that when executed implement embodiments of the present invention. For instance, the machine-readable medium may contain a program configured to perform some or all of the steps of the lookup engine 315. The machine-readable medium may be, for instance, a recordable medium such as a hard drive, an optical or magnetic disk, an electronic memory, or other storage device.

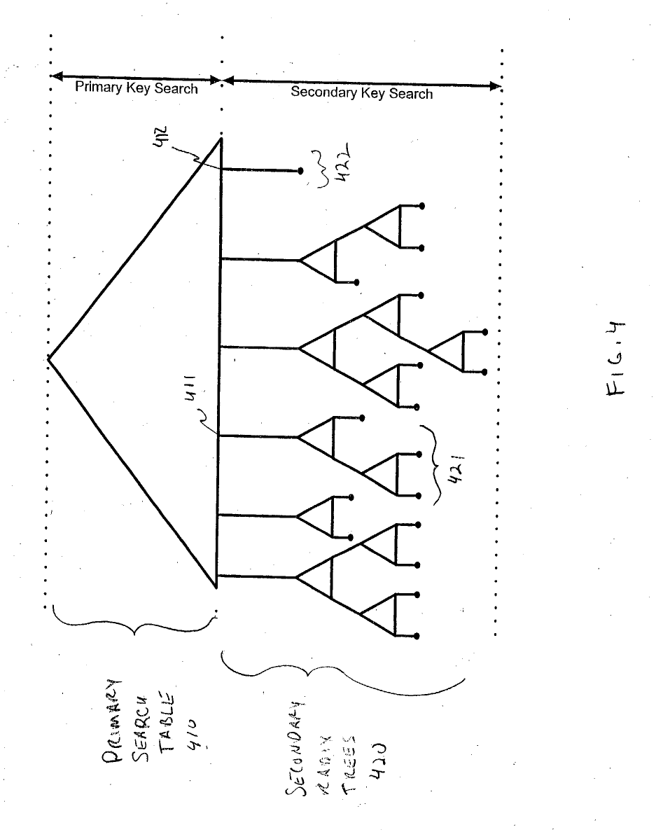

Turning now to FIG. 4, a diagram is shown of an exemplary logical search architecture for primary and secondary key address lookups. FIG. 4 and additional figures assume that the network switch 300 of FIG. 3 is switching ATM cells (not shown in FIG. 3). The logical architecture shown in FIG. 4 is combination of a primary search table 410 and a number of secondary radix trees. The primary key search is done by direct mapping address lookup and the secondary key search is done by searching a secondary radix tree 420. The secondary radix trees 420 are beneficially selector look-ahead reduced radix trees, which are described in more detail below.

A primary search result such as primary search result 411 can reference a secondary radix tree such as secondary radix tree 421. Alternatively, a primary search result such as search result 412 can access a secondary radix tree that is a leaf, as indicated by secondary radix tree 422. In this situation, there is no need to search the secondary radix tree 422, as it is a leaf and contains a connection ID.

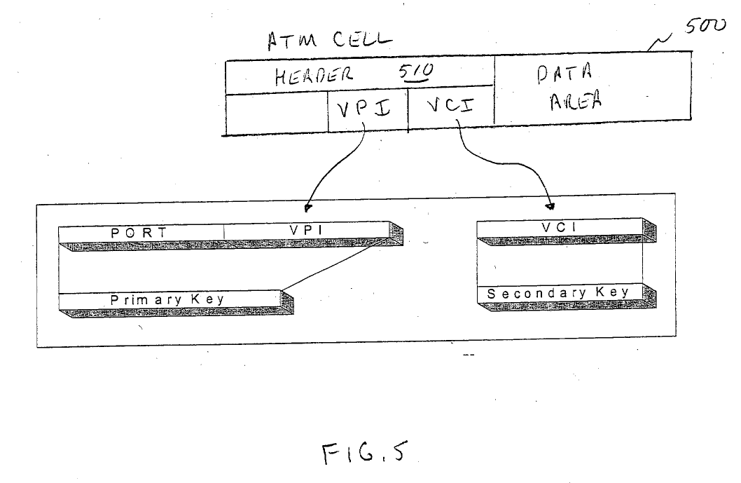

FIG. 5 is an example of primary and secondary keys for an ATM communication system. The primary key comprises the input port and virtual path identifier (VPI) of a received ATM cell 500. The secondary key is the VCI of a received ATM cell. The VPI and VCI are generally stored in the header 510 of the ATM cell 500.

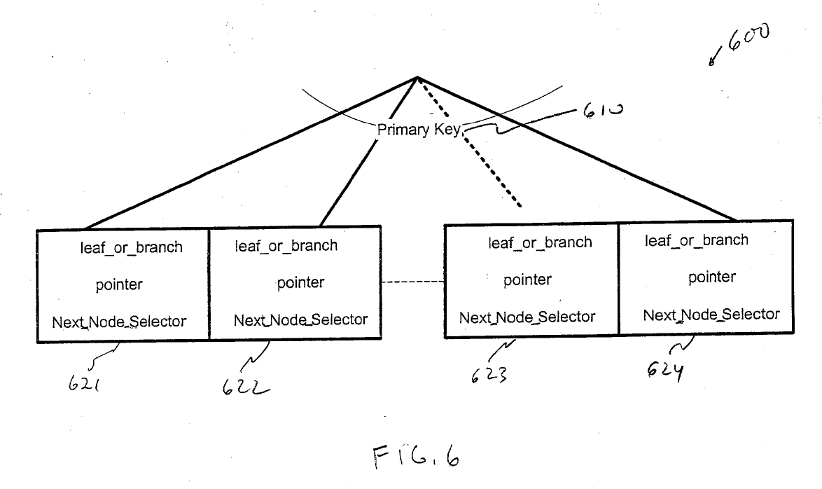

Turning now to FIG. 6, an exemplary primary key search table 600 is shown. Searching using primary key 610 may be performed as follows. Primary key search table 600 is a series of basic data structures 621, 622, 623, and 624. Each basic data structure 621-624 has node information comprising a leaf_or_branch field, a pointer field, and a Next_Node_Selector field. The leaf_or_branch field indicates whether the searching is completed (e.g., leaf) or not (e.g., branch). The pointer field references the next node address if the leaf_or_branch field indicates the node is a branch, or to a connection ID if the leaf_or_branch field indicates the next node is a leaf. If the searching is not completed and a jump to another node is required, then the selector_of_next_node field indicates which bit of the secondary key (not shown) will be compared to determine the node to which to jump. The size of primary key search table will be 2^{x}, if it is assumed that the primary key 610 bit width is “x.”

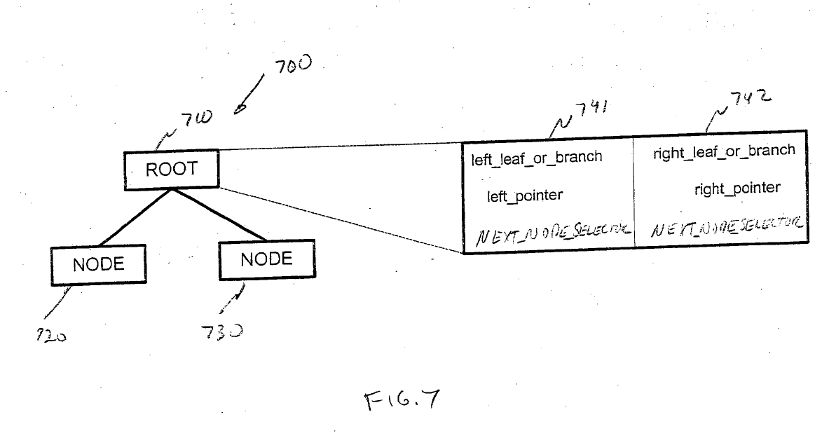

FIG. 7 is a block diagram of an exemplary secondary radix tree 700 and exemplary node information associated therewith. A secondary radix tree 700 is comprised of one or more nodes. The secondary radix tree 700 in this example comprises a root node 710 and two nodes 720, 730. The secondary radix tree 700 is preferably comprised of a selector look-ahead reduced radix tree, which is described in more detail below. A node (such as node 710) contains two basic data structures 741, 742 in this example. The root node 710 is the starting point of a secondary key search of the secondary radix tree 700. The primary search result of the primary key search using the primary key search table 600 of FIG. 6 is a pointer to the root node 710 of the secondary radix tree 700.

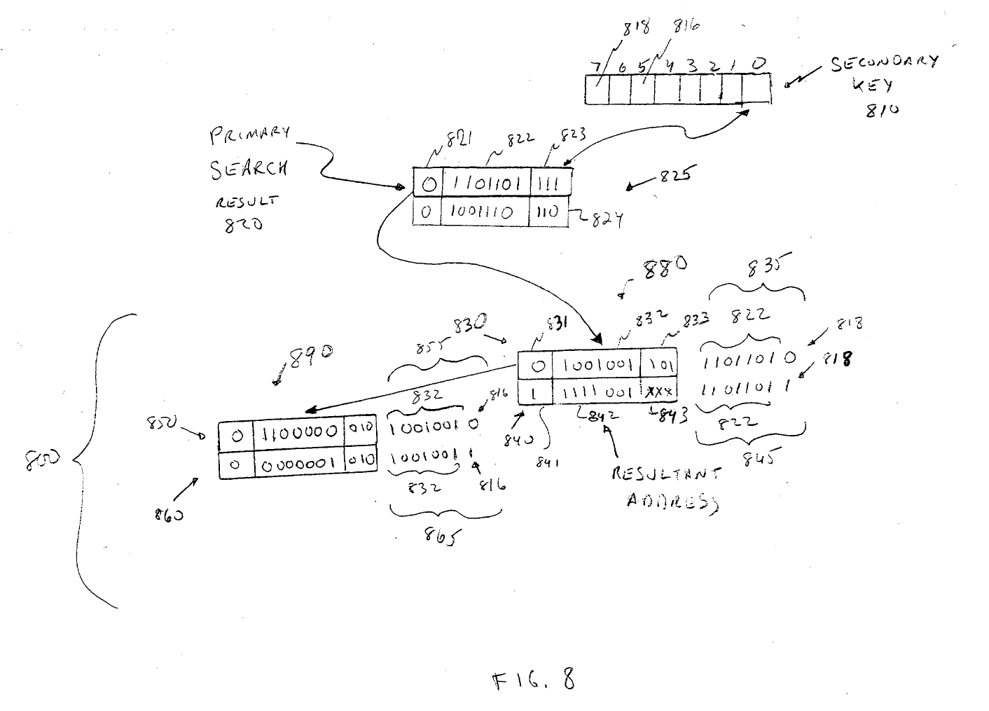

Turning now to FIG. 8, a selector look-ahead reduced radix tree 800, for secondary key address lookup, and a primary search result 820 used to access the selector look-ahead reduced radix tree 800 are shown. The selector look-ahead reduced radix tree 800 is shown having two nodes: one node 880 comprises sub-nodes 830 and 840; and a second node 890 comprises sub-nodes 850 and 860. Each of the sub-nodes 830, 840, 850, and 860 is implemented as a basic data structure (see, e.g., basic data structures 621-624 of FIG. 6 and basic data structures 741, 742 of FIG. 7).

The primary search result 820 is, for instance, the result of a primary key search on the primary key search table 600 of FIG. 6. In this example, there is a primary node 825 having sub-node 820 (i.e., the primary search result) and sub-node 824. The primary search result 820 is implemented as comprising a basic data structure (see, e.g., basic data structures 621-624 of FIG. 6 and basic data structures 741, 742 of FIG. 7), as is the sub-node 824. In this example, the leaf_or_branch field 821 of the primary search result 820 is a zero, meaning that the pointer 822 references a branch. The Next_Node_Selector field 823 is “111,” which points to bit 818 (i.e., bit seven) of the secondary key 810. The Next_Node_Selector field 823 means that the value of bit 818 can be determined before a memory access is made to retrieve either sub-node 830 or sub-node 840. In conventional systems, a data structure having information from an entire node (see, e.g., node 235 of FIG. 2) would have to be retrieved, whereas here only sub-node 830 or sub-node 840 from node 880 is retrieved.

In this example, the pointer 822 is combined with the bit 818 by appending the bit 818 to generate a memory address. If bit 818 is a one, the memory address 845, of “11011011,” is generated. The memory address 845 can be used to access sub-node 840. Sub-node 840 indicates, through the leaf_or_branch field 841 that a leaf has been accessed. In this example, the pointer 842 is the resultant address and the value in Next_Node_Selector field 843 is immaterial. The resultant address is the connection ID, which can be used to provide VC context. As another illustration, the Next_Node_Selector field 843 could include additional connection ID information, if desired. Furthermore, the pointer 842 can be used, instead, to access a memory location where the connection ID is stored.

If bit 818 is a zero, the memory address 835, of “11011010,” is generated. Memory address 835 references sub-node 830. Sub-node 830 indicates, through its leaf_or_branch field 831, that a branch follows. The pointer 832 is used to access either sub-node 850 or sub-node 860. The Next_Node_Selector field 833 selects the fifth bit of the secondary key 810. The value of bit 816 (i.e., bit five) of the secondary key 810 is determined in order to determine a memory address using the pointer 832. When bit 810 is zero, the value of a determined memory address 855 is “10010010,” which references sub-node 850. When bit 810 is one, the value of a determined memory address 865 is “10010011,” which references sub-node 860.

A benefit of having the Next_Node_Selector field (such as Next_Node_Selector field 823) select the appropriate bit of the secondary key 810 for the next node is that fewer memory accesses are required. For instance, in the system of FIG. 2 (and referring to FIG. 2 if necessary), the selector 240 selects a bit of the secondary key 810 for the current node. The entire node information 235 is generally accessed from memory, and it can take several memory accesses to access the node information 235. In FIG. 8, the current node already contains a selector for the next node. This means that a single memory address corresponding to only the necessary node information need be accessed. For instance, the memory address 855 or memory address 865 is chosen based on a combination of the pointer 832 in sub-node 830 and the value of bit 816 selected by the next node selector 833 in sub-node 830. A single memory access can be performed to retrieve exactly the information needed to continue searching the selector look-ahead reduced radix tree 800. The selector look-ahead reduced radix tree 800 is called “selector look-ahead” because the Next_Node_Selector field selects a bit of the secondary key 810 for the next node instead of the current node. Thus, fewer memory accesses are performed using the techniques shown in FIG. 8.

The selector look-ahead reduced radix tree 800 is called “reduced” because only those nodes used to determine important bits in the resultant address are placed into the selector look-ahead reduced radix tree 800.

Although the memory address in FIG. 8 is calculated by appending the value of the bit of the secondary key 810 to a pointer (such as pointer 822), any technique for generating an address may be used. For instance, a value of zero in a bit of the secondary key 810 could indicate that the pointer is not shifted, while a value of one in a bit of the secondary key 810 could indicate that the pointer is shifted to the left one bit.

FIG. 9 shows an exemplary lookup engine 900, implementable at least in part in hardware such as a field programmable gate array (FPGA), for performing secondary key address lookups using the secondary radix tree structure of FIG. 7. Lookup engine 900 may be implemented as part of a processor for a network switch, as shown in FIG. 3. Lookup engine 900 accesses lookup memory 940. The lookup engine 900 comprises three multiplexers (MUXs) 910, 920, and 930. A search is performed by exemplary lookup engine 900 when the primary key search does not find a leaf. The primary key search process generates the root node pointer and the selector to point to a bit of the secondary key. The combination of the root pointer and the secondary search key bit pointed to by the selector generates an address into the lookup memory 940. The lookup memory 940 comprises basic data structures (e.g., see basic data structures 621-624 of FIG. 6 and basic data structures 741, 742 of FIG. 7) containing a leaf_or_branch field, a pointer field, and a Next_Node_Selector field. The pointer is routed to MUX 910, while the selector is routed to MUX 920. If the leaf_or_branch field (not shown) indicates a leaf (e.g., by a value of 1) then the search is completed. Otherwise, the secondary key search continues until a leaf is found.

Initially, MUX 920 selects the selector (e.g., the Next_Node_Selector field) 970 of the primary search result. Once the secondary key search starts, the MUX 920 selects the selector (e.g., the Next_Node_Selector field) from the lookup memory 940. The selector 980 is passed to the MUX 930, which uses selector 980 to select a bit 991 of the secondary search key 990. The bit 991 is used as the least significant line of the address passed to the lookup memory 940. The upper bits of address are from the pointer (either from a pointer to the root node of the secondary radix tree or a pointer from the lookup memory 940) from MUX 910. The pointer is placed onto address bus 950.

A secondary key search may be performed in the following manner, as shown by pseudocode.

```
        Step 1. current_node = secondary_table(
(pointer << 1) + secondary_key(selector) );
        Step 2. if current_node.leaf_or_branch ==
1 then connection identifier <= current_node.pointer
and search completed;
        Step 3. else pointer = current_node.pointer,
selector = current_node.selector_of_next_node;
        Step 4. goto Step 1.
```

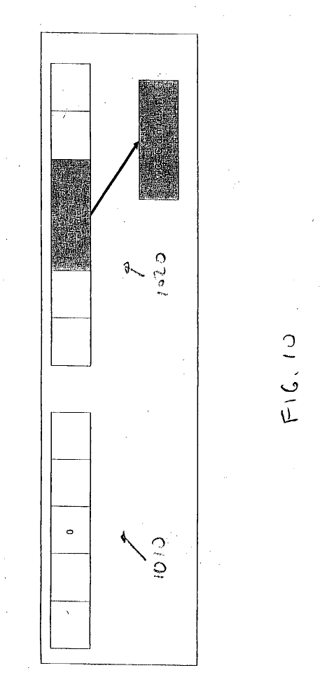

FIG. 10 illustrates adding and removing ATM connections when a secondary radix tree is empty. Reference numeral 1010 illustrates an empty basic data structure in a primary search table, while reference numeral 1020 illustrates the primary search table after a VC context has been added to create a leaf of a secondary radix tree. The “VC context” in the following figures is a basic data structure that contains a connection ID pointing to VC context. To add a new connection, set the primary key basic data structure, as shown in the following pseudocode:

leaf_or_branch = 1;
pointer = connection identifier for the connection;
selector = 0.

To delete a connection, set the primary key basic data structure as null.

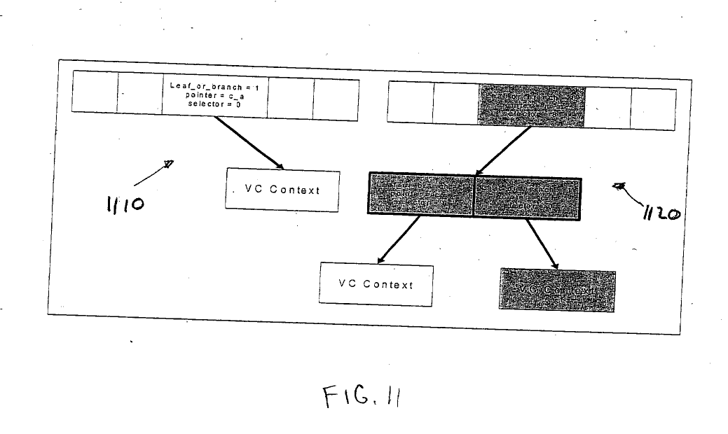

FIG. 11 illustrates adding and removing ATM connections when a secondary radix tree contains only a single VC context. Reference numeral 1110 illustrates a primary search table and a single pointer to a leaf, while reference numeral 1120 illustrates a primary search table with a secondary radix tree with multiple entries. To add a new connection, set the primary key basic data structure and secondary radix tree entries as follows:

Selector=MSB position which distinguishes the current and the new connections;

| | | |
|---|---|---|
| | Create(node); | |
| | Node.left.leaf_or_branch | = Node.right_leaf_or_{—} |
| | | branch = 1; |
| | Node.left_selector | = Node.right.selector = 0; |
| | Node.left.pointer | = connection id whose secondary_{—} |
| | | key(selector) == |
| 1; | | |
| | Node.right.pointer | = connection id whose secondary_{—} |
| | | key(selector) == |
| 0; | | |
| | Primary.leaf_or_branch | = 0; primary.pointer = |
| | | node; primary.selector = |
| selector. | | |

To delete a new connection, set the primary key basic data structure and secondary radix tree entries in the reverse order of the addition.

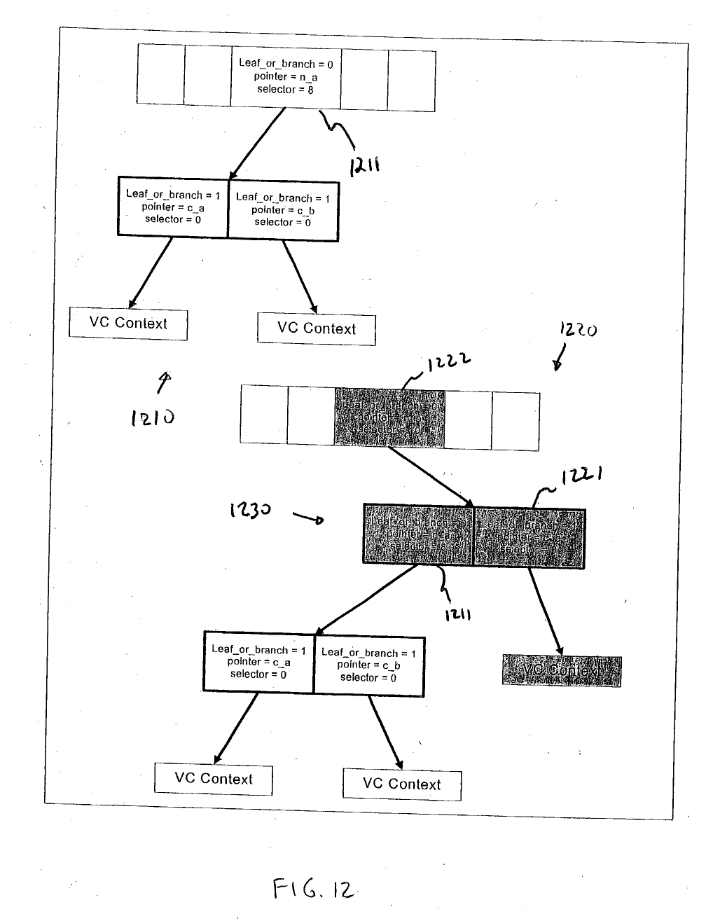

FIG. 12 illustrates adding and removing ATM connections when the insertion point is at the root of the secondary radix tree. Reference numeral 1210 shows a primary search tree and a secondary radix tree before insertion of new nodes, while reference numeral 1220 shows the primary search tree and the secondary radix tree after insertion of a new node. A new sub-node 1222 is inserted in the primary search tree. This example assumes {secondary_key(selector) of new connection==0}, which implies that {secondary_key(selector) of old connection==1}. As a result, the new connection is added to the right of the new node 1230, via sub-node 1221, and the old tree is attached to the left of the new node 1230, via sub-node 1211. Addition in this instance may be performed as follows:

Selector=MSB position which distinguishes the current and the new connections;

| Create(node); | |
|---|---|
| If secondary_key(selector) of new connection == 1; | |
| Node.left.leaf_or_branch | = 1; |
| Node.left.selector | = 0; |
| Node.left.pointer | = connection identifier of new |
| | connection; |
| Node.right.leaf_or_branch | = 0; |
| Node.right.selector | = primary.selector; |
| Node.right.pointer | = old_node; |
| Primary.selector | = selector; |
| Primary.leaf_or_branch | = 0; |
| Primary.pointer | = node; |
| Else | |
| Node.right.leaf_or_branch | = 1; |
| Node.right.selector | = 0; |
| Node.right.pointer | = connection identifier of new |
| | connection; |
| Node.left.leaf_or_branch | = 0; |
| Node.left.selector | = primary.selector; |
| Node.left.pointer | = old_node; |
| Primary.selector | = selector; |
| Primary.leaf_or_branch | = 0; |
| Primary.pointer | = node; |
| End if; | |

Deletion of a connection may be performed in the reverse order.

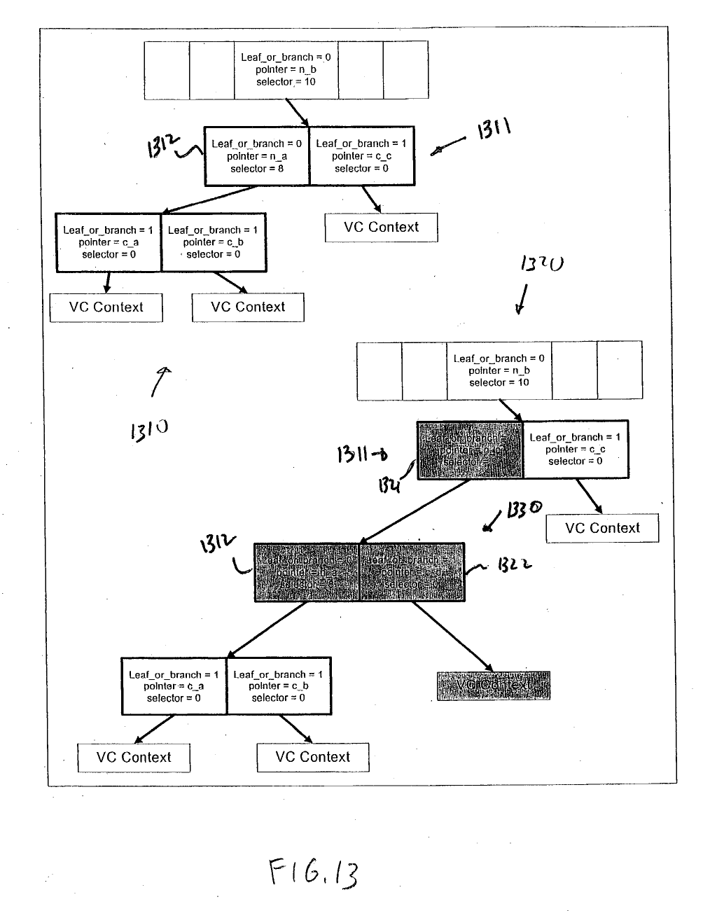

FIG. 13 illustrates adding and removing ATM connections when the insertion point is in the middle of the secondary radix tree. Reference numeral 1310 shows a primary search tree and a secondary radix tree before insertion of new nodes, while reference numeral 1320 shows the primary search tree and the secondary radix tree after insertion of new nodes. This example assumes that the new node 1330 is to the left of the UpperNode 1311 (via sub-node 1321) and that {secondary_key(selector) of the new connection==0}, which implies that {secondary_key(selector) of old connection==1}. As a result, the new connection is added to the right of the new node 1330, via sub-node 1322, and the old tree is attached to the left of the new node 1320, via sub-node 1312. Addition in this instance may be performed as follows:

Selector=MSB position which distinguishes the LowerNode and the new connections;

| UpperNode; LowerNode; | |
|---|---|
| Create(node); | |
| If Node is left of UpperNode | |
| If secondary_key(selector) of new connection == 1; | |
| Node.left.leaf_or_branch | = 1; |
| Node.left.selector | = 0; |
| Node.left.pointer | = connection identifier of |

new connection;

| | |
|---|---|
| Node.right.leaf_or_branch | = 0; |
| Node.right.selector | = UpperNode.left.selector; |
| Node.right.pointer | = LowerNode; |
| UpperNode.left.selector | = selector; |
| UpperNode.left.leaf_or_branch | = 0; |
| UpperNode.left.pointer | = node; |
| Else | |
| Node.right.leaf_or_branch | = 1; |
| Node.right.selector | = 0; |
| Node.right.pointer | = connection identifier of |

new connection;

| Node.left.leaf_or_branch | = 0; |
|---|---|
| Node.left.selector | = UpperNode.left.selector; |
| Node.left.pointer | = LowerNode; |
| UpperNode.left.selector | = selector; |
| UpperNode.left.leaf_or_branch | = 0; |
| UpperNode.left.pointer | = node; |
| End if; | |
| Else | |
| If secondary_key(selector) of new connection == 1; | |
| Node.left.leaf_or_branch | = 1; |
| Node.left.selector | = 0; |
| Node.left.pointer | = connection identifier of |

new connection;

| | |
|---|---|
| Node.right.leaf_or_branch | = 0; |
| Node.right.selector | = UpperNode.right.selector; |
| Node.right.pointer | = LowerNode; |
| UpperNode.right.selector | = selector; |
| UpperNode.right.leaf_or_branch | = 0; |
| UpperNode.right.pointer | = node; |
| Else | |
| Node.right.leaf_or_branch | = 1; |
| Node.right.selector | = 0; |
| Node.right.pointer | = connection identifier of |
| new connection; | |
| Node.left.leaf_or_branch | = 0; |
| Node.left.selector | = UpperNode.right.selector; |
| Node.left.pointer | = LowerNode; |
| UpperNode.right.selector | = selector; |
| UpperNode.right.leaf_or_branch | = 0; |
| UpperNode.right.pointer | = node; |
| End if; | |
| End if; | |

Deletion of a connection may be performed in the reverse order.

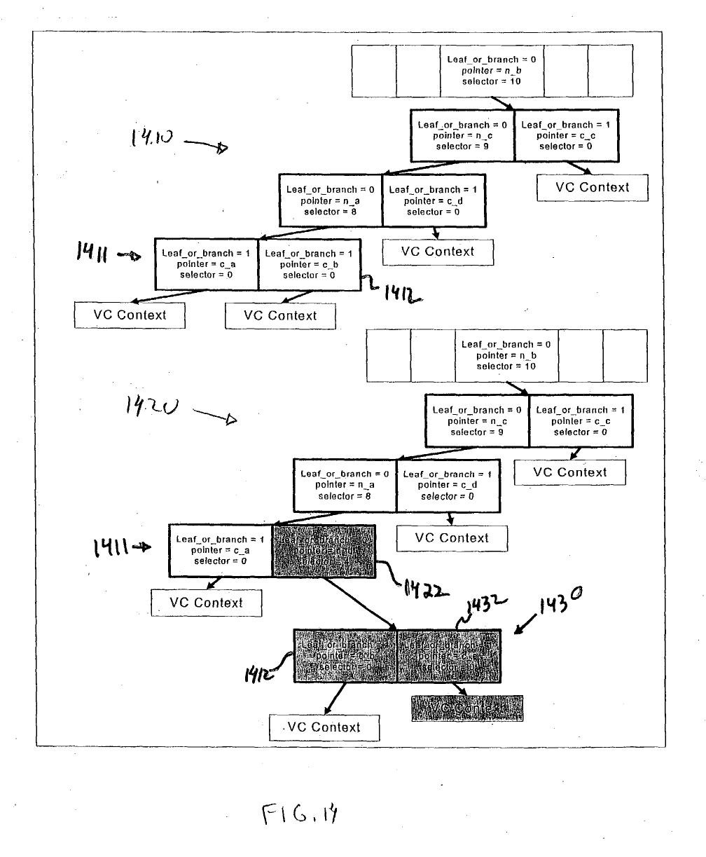

FIG. 14 illustrates adding and removing ATM connections when a new entry is inserted at a leaf of the secondary radix tree. Reference numeral 1410 shows a primary search tree and a secondary radix tree before insertion of new nodes, while reference numeral 1420 shows the primary search tree and the secondary radix tree after insertion of new nodes. The example assumes that the new node 1403 (added via sub-node 1422) is to the right of the UpperNode 1411 and that {secondary_key(selector) of new connection==0}, which implies that {secondary_key(selector) of old connection==1}. As a result, the new connection is added to the right of the new node 1430 via sub-node 1432 and the old connection is attached to the left of the new node via sub-node 1412. Addition in this instance may be performed as follows:

Selector=MSB position which distinguishes the leaf and the new connections;

| UpperNode; | |
|---|---|
| Create(node); | |
| If Node is left of UpperNode | |
| If secondary_key(selector) of new connection == 1; | |
| Node.left.leaf_or_branch | = 1; |
| Node.left.selector | = 0; |
| Node.left.pointer | = connection identifier of |

new connection;

| | |
|---|---|
| Node.right.leaf_or_branch | = 1; |
| Node.right.selector | = 0; |
| Node.right.pointer | = UpperNode.left.pointer; |
| UpperNode.left.selector | = selector; |
| UpperNode.left.leaf_or_branch | = 0; |
| UpperNode.left.pointer | = node; |
| Else | |
| Node.left.leaf_or_branch | = 1; |
| Node.left.selector | = 0; |
| Node.left.pointer | = UpperNode.left.pointer; |
| Node.right.leaf_or_branch | = 1; |
| Node.right.selector | = 0; |
| Node.right.pointer | = connection identifier of |

new connection;

| UpperNode.left.selector | = selector; |
|---|---|
| UpperNode.left.leaf_or_branch | = 0; |
| UpperNode.left.pointer | = node; |
| End if; | |
| Else | |
| If secondary_key(selector) of new connection == 1; | |
| Node.left.leaf_or_branch | = 1; |
| Node.left.selector | = 0; |
| Node.left.pointer | = connection identifier of |

new connection;

| | |
|---|---|
| Node.right.leaf_or_branch | = 1; |
| Node.right.selector | = 0; |
| Node.right.pointer | = UpperNode.right.pointer; |
| UpperNode.right.selector | = selector; |
| UpperNode.right.leaf_or_branch | = 0; |
| UpperNode.right.pointer | = node; |
| Else | |
| Node.left.leaf_or_branch | = 1; |
| Node.left.selector | = 0; |
| Node.left.pointer | = UpperNode.right.pointer; |
| Node.right.leaf_or_branch | = 1; |
| Node.right.selector | = 0; |
| Node.right.pointer | = connection identifier of |

new connection;

| | |
|---|---|
| UpperNode.right.selector | = selector; |
| UpperNode.right.leaf_or_branch | = 0; |
| UpperNode.right.pointer | = node; |
| End if; | |
| End if; | |

Deletion of a connection may be performed in the reverse order.

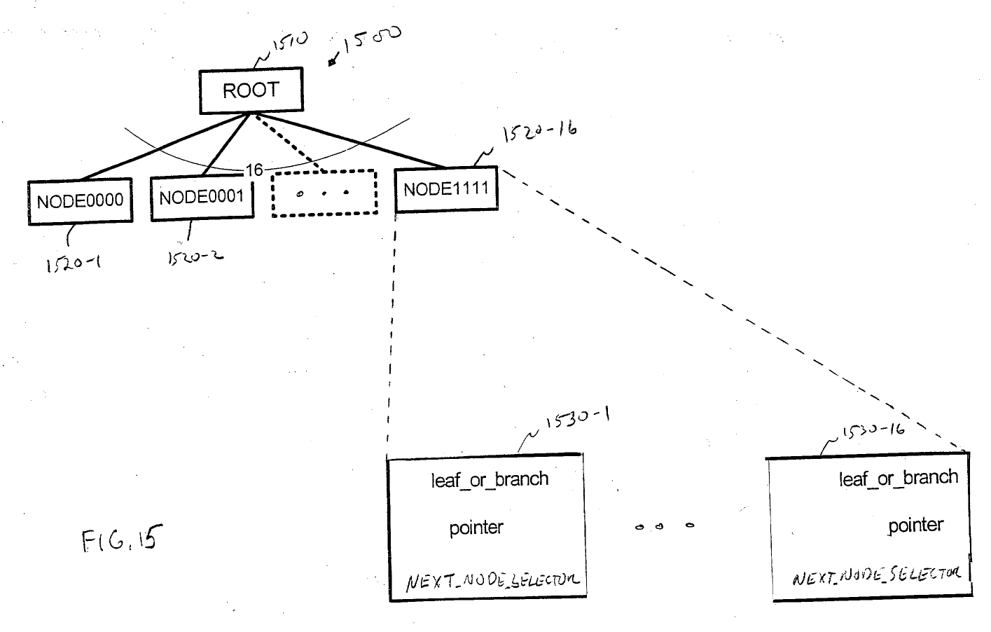

A benefit to certain aspects of the present invention is the symmetric memory structure of the basic data structure used as node information herein. Referring now to FIG. 15, an exemplary secondary radix tree 1500 and exemplary node information associated therewith are shown for a radix-4 tree used for ATM secondary key address lookup. The secondary radix tree 1500 comprises a root node 1510 and 16 nodes 1520-1 through 1520-16. Each node 1520 comprises 16 basic data structures 1530-1 through 1530-16. The memory structure of the basic data structure is symmetric in that additional radix levels may be utilized per node merely by adding additional basic data structures 1530. By contrast, the data structure 235 used in FIG. 2 requires the data structure 235 itself to be rewritten. Also, with a radix-4 tree, the selector look-ahead property of the present invention allows one of sixteen basic data structures to be selected for each secondary key bit comparison. This allows a single memory access, for instance, to retrieve one of the single basic data structures. In the example of FIG. 2, if implemented as a radix-4 tree, all sixteen leaf/branch information portions (such as leaf/branch information portions 250, 260, 270, and 280) would have to be retrieved, requiring multiple memory accesses.

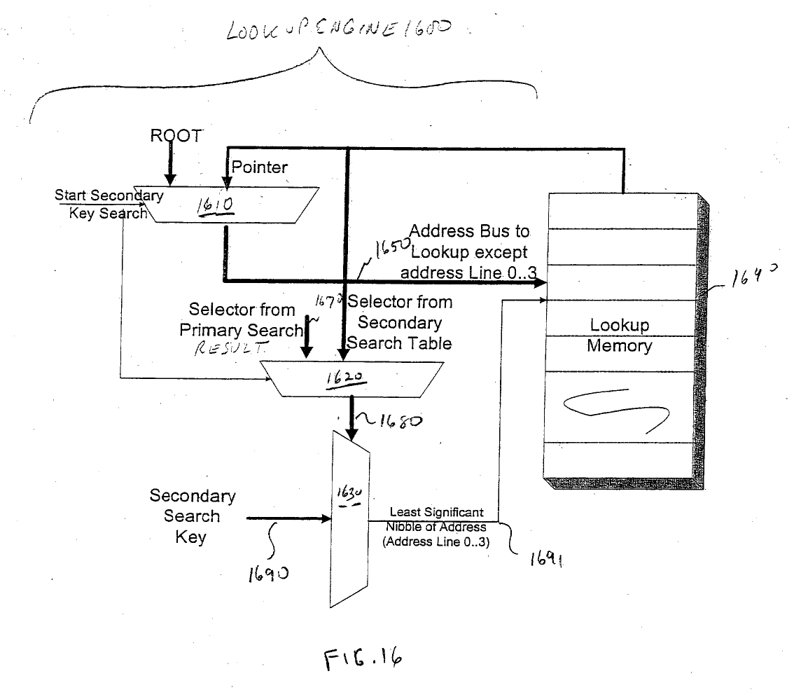

Turning now to FIG. 16, an exemplary lookup engine 1600 for performing secondary key address lookups using the secondary radix tree structure of FIG. 15. FIG. 16 shows an exemplary lookup engine 1600, implemented in hardware such as a field programmable gate array (FPGA), for performing secondary key address lookups using the secondary radix tree structure of FIG. 15. Lookup engine 1600 may be implement as part of a processor for a network switch, as shown in FIG. 3. Lookup engine 1600 accesses lookup memory 1640. The lookup engine 1600 comprises three multiplexers (MUXs) 1610, 1620, and 1630. A search is performed by exemplary lookup engine 1600 when the primary key search does not find a leaf. The primary key search process generates the root node pointer and the selector to point to a four-bit field of the secondary key. The combination of the root pointer and the four-bit secondary search key field pointed to by the selector generates an address into the lookup memory 1640. The lookup memory 1640 comprises basic data structures (e.g., see basic data structures 621-624 of FIG. 6 and basic data structures 741, 742 of FIG. 7) containing a leaf_or_branch field, a pointer field, and a Next_Node_Selector field. The pointer is routed to MUX 1610, while the selector is routed to MUX 1620. If the leaf_or_branch field (not shown) indicates a leaf (e.g., by a value of 1) then the search is completed. Otherwise, the secondary key search continues until a leaf is found.

Initially, MUX 1620 selects the selector (e.g., the Next_Node_Selector field) 1670 of the primary search result. Once the secondary key search starts, the MUX 1620 selects the selector (e.g., the Next_Node_Selector field) from the lookup memory 1640. The selector 1680 is passed to the MUX 1630, which uses selector 1680 to select four bits 1691 of the secondary search key 1690. The four bits 1691 are used as the least significant nibble of the address passed to the lookup memory 1640. The upper bits of address are from the pointer (either from a pointer to the root node of the secondary radix tree or a pointer from the lookup memory 1640) from MUX 1610. The pointer is placed onto address bus 1650.

A search process using the lookup engine 1600 may be performed as follows:

```
        Step 1. current_node = secondary_table(
(pointer << 4) + secondary_key(selector))
        Step 2. if current_node.leaf_or_branch == 1 then connection
identifier = current_node.pointer and search completed.
        Step 3. else pointer = current_node.pointer,
selector = current_node.selector_of_next_node
        Step 4. goto Step 1.
```

It is to be understood that the embodiments and variations shown and described herein are merely illustrative of the principles of this invention and that various modifications may be implemented by those skilled in the art without departing from the scope and spirit of the invention. For instance, the primary search table could be implemented as a selector look-ahead reduced radix tree, if desired. As another example, the secondary radix tree could be implemented as a full radix tree. As yet another example, the techniques presented herein may be applied to any memory structure where selector look-ahead is beneficial. There is no requirement, for example, that each node reference 2ⁿ possible branches per node. Instead, a node could reference five possible branches per node, if desired.

What is claimed is:

1. A method for processing input data in conjunction with an address lookup, the method utilizing a plurality of node information structures, wherein at least one of the node information structures is part of a radix tree, the method comprising the steps of:
selecting, by using a next node selector from a first node information structure, one or more bits of the input data, wherein the first node information structure further comprises a pointer; and
performing one or more memory accesses by using at least one memory address defined at least in part by the selected one or more bits and the pointer from the first node information structure, the one or more memory accesses accessing another node information structure comprising another pointer,
the pointers being utilizable in determination of a resultant address in the address lookup.

2. The method of claim 1, wherein the step of performing one or more memory accesses further comprises the step of determining the at least one memory address by combining the pointer from the first node information structure and the one or more selected bits.

3. The method of claim 2, wherein the step of determining the at least one memory address further comprises the step of determining the at least one memory address by appending the one or more selected bits to the pointer from the first node information structure.

4. The method of claim 1, wherein the additional node information further comprises a leaf/branch indicator and an additional next node selector.

5. The method of claim 4, wherein the method further comprises the steps of:
selecting, by using the additional next node selector from the additional node information structure, additional one or more selected bits of the input data when the leaf/branch indicator of the additional node information structure indicates a branch; and
performing, when the leaf/branch indicator of the addition node information indicates a branch, one or more memory accesses by using at least one memory address defined at least in part by the additional one or more selected bits and the pointer from the additional node information, the one or more memory accesses accessing additional node information comprising another pointer.

6. The method of claim 5, further comprising the step of:
performing the steps of selecting, by using the additional next node selector from the additional node information, additional one or more selected bits and performing, when the leaf/branch indicator of the addition node information indicates a branch, one or more memory accesses until the leaf/branch indicator of the additional node information indicates a leaf,
wherein the pointer in the additional node information having the leaf/branch indicator indicating a leaf comprises a resultant address.

7. The method of claim 6, wherein the resultant address comprises a connection identifier.

8. The method of claim 7, further comprising the step of using the connection identifier to determine a virtual channel context.

9. The method of claim 1, further comprising the step of accessing a primary search table using a primary key in order to determine the first node information structure.

10. The method of claim 9, wherein the primary key comprises a port identifier and a virtual path identifier.

11. The method of claim 9, wherein the step of accessing a primary search table further comprises the step of accessing the primary search table by direct access in order to determine the first node information structure.

12. The method of claim 9, wherein the pointer from the first node information structure references a root node of a secondary key radix tree, whereby the root node comprises the other node information structure.

13. The method of claim 1, wherein the input data comprises a secondary key.

14. The method of claim 13, wherein the secondary key comprises a virtual channel identifier.

15. An apparatus for processing input data in conjunction with an address lookup, the apparatus utilizing a plurality of node information structures, wherein at least one of the node information structures is part of a radix tree, comprising:
a memory configurable to store the plurality of node information structures; and
at least one processor, coupled to the memory, operative:
to select, by using a next node selector from, a first node information structure, one or more bits of the input data, wherein the first node information structure further comprises a pointer; and
to perform one or more memory accesses by using at least one memory address defined at least in part by the selected one or more bits and the pointer from the first node information structure, the one or more memory accesses accessing another node information structure comprising another pointer, the pointers being utilizable in determination of a resultant address in the address lookup.

16. The apparatus of claim 15, further comprising:
a first multiplexer adapted to select one or more bits of input data from either the first node information structure or the other node information structure;
a second multiplexer adapted to select a memory address comprising either the pointer from the first node information structure or a pointer from the other node information structures,
wherein the selected one or more bits of input data and the selected memory address are coupled to the memory to address at least a pointer of one of the node information structures, wherein the addressed pointer is coupled to the second multiplexer.

17. An article of manufacture for processing input data in conjunction with an address lookup, wherein at least one of the node information structures is part of a radix tree, comprising:
a machine readable medium containing one or more programs which when executed implement the steps of:
selecting, by using a next node selector from a first node information structure, one or more bits of the input data, wherein the first node information structure further comprises a pointer; and
performing one or more memory accesses by using at least one memory address defined at least in part by the selected one or more bits and the pointer from the first node information structure, the one or more memory accesses accessing another node information structure comprising another pointer, the pointers being utilizable in determination of a resultant address in the address lookup.
